(19) United States
(12) Patent Application Publication
(10) Pub. No.: US 2024/0193798 A1
(43) Pub. Date: Jun. 13, 2024

(54) IMAGE-TO-DESIGN ALIGNMENT FOR IMAGES WITH COLOR OR OTHER VARIATIONS SUITABLE FOR REAL TIME APPLICATIONS

(71) Applicant: KLA Corporation, Milpitas, CA (US)

(72) Inventors: Jun Jiang, Chapel Hill, NC (US); Huan Jin, Dublin, CA (US); Zhifeng Huang, Milpitas, CA (US); Wei Si, Shanghai (CN); Xiaochun Li, San Jose, CA (US)

(21) Appl. No.: 18/078,980

(22) Filed: Dec. 11, 2022

(51) Int. Cl. G06T 7/33; G06T 7/00; G06T 11/00

(52) U.S. Cl. CPC G06T 7/344; G06T 7/001; G06T 11/00; G06T 2207/30148; G06T 2207/30168

(57) ABSTRACT

Methods and systems for determining information for a specimen are provided. One system includes a model configured for generating a rendered image for an alignment target on a specimen from information for a design of the alignment target. The rendered image is a simulation of images of the alignment target on the specimen generated by an imaging subsystem. The system also includes a computer subsystem configured for modifying parameter(s) of the model based on variation in parameter(s) of the imaging subsystem and/or variation in process condition(s) used to fabricate the specimen. Subsequent to the modifying, the computer subsystem is configured for 10 generating an additional rendered image for the alignment target by inputting the information for the design of the alignment target into the model and aligning the additional rendered image to an image of the alignment target generated by the imaging subsystem.

### BACKGROUND OF THE INVENTION

### 1. Field of the Invention

The present invention generally relates to methods and systems for determining information for a specimen. Certain embodiments relate to modifying a model used to generate a rendered alignment target image based on imaging subsystem parameter variation and/or process condition variation and using the modified model to generate a rendered alignment target image for alignment with a specimen image.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

One aspect of the methods and systems described above that can be difficult is knowing where on a specimen a result, e.g., a measurement, a detected defect, a re-detected defect, etc., is generated. For example, the tools and processes described above are used to determine information about structures and/or defects on the specimen. Since the structures vary across the specimen (so that they can form a functional device on the specimen), a measurement, inspection, or defect review result is generally useless unless it is known precisely where on the specimen it was generated. In a metrology example, unless a measurement is performed at a known, predetermined location on the specimen, the measurement may fail if the measurement location does not contain the portion of the specimen intended to be measured and/or the measurement of one portion of the specimen is assigned to another portion of the specimen. In the case of inspection, unless a defect detection is performed at a known, predetermined area on the specimen, e.g., in a care area (CA), the inspection may not be performed in the manner intended. In addition, unless a defect location on the specimen is determined substantially accurately, the defect location may be inaccurately determined with respect to the specimen and/or the design for the specimen. In any case, errors in the locations on the specimen at which results were generated can render the results useless and can even be detrimental to a fabrication process if the results are used to make changes to the fabrication process.

Images or other output generated for a specimen by one of the tools described above may be aligned to a common reference in a number of different ways. When the alignment has to be performed substantially quickly, as in when, during an inspection, CA placements are being determined as the specimen is being scanned, many alignment processes try to make the alignment quicker by aligning one image generated for the specimen to another, substantially similar image that is available on demand or can be generated quickly. For example, in the case of optical inspection, the alignment process may be designed for alignment of real optical images of the specimen generated by the inspection tool to a rendered optical image that is generated and stored before inspection and can be quickly accessed during inspection. The alignment of the real and rendered optical images may be performed only for alignment targets on the specimen and then any coordinate transform determined thereby may be applied to other real optical images of the specimen generated during the scanning. When the rendered optical image is previously aligned to some reference coordinate system, like design coordinates of a design for the specimen, the real optical images may be also aligned to the same reference coordinate system.

There are, however, several disadvantages to such alignment methods. For example, the images of the specimen generated during a process like inspection may vary in ways that may be difficult to predict. The images of the specimen may vary from specimen to specimen or even across a specimen, which makes using the same previously generated and stored alignment target image substantially difficult. For example, the real optical images may be different from expected to such a degree that alignment of those images to the previously generated and stored alignment target image is substantially difficult or even impossible. Errors in the alignment of the real images to the rendered images can have significant and even disastrous effects on the processes described above. For example, if an inspection tool incorrectly aligns a real optical image to the previously generated and stored rendered image, CAs may be incorrectly located in the real optical images. Incorrectly located CAs can have a couple of different effects on the inspection results including, but not limited to, missed defects, falsely detected defects, and errors in any results of analysis of the detected defects. If inspection results with such errors are used to make corrections to a fabrication process performed on the specimen, that could have even further disastrous consequences such as pushing a fabrication process that was functioning correctly out of its process window or pushing a fabrication process that was out of its process window even farther out of its process window.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured to determine information for a specimen. The system includes an imaging subsystem configured to generate images of the specimen. The system also includes a model configured for generating a rendered image for an alignment target on the specimen from information for a design of the alignment target. The rendered image is a simulation of the images of the alignment target on the specimen generated by the imaging subsystem. The system further includes a computer subsystem configured for modifying one or more parameters of the model based on one or more of variation in one or more parameters of the imaging subsystem and variation in one or more process conditions used to fabricate the specimen. Subsequent to the modifying, the computer subsystem is configured for generating an additional rendered image for the alignment target by inputting the information for the design of the alignment target into the model. In addition, the computer subsystem is configured for aligning the additional rendered image to at least one of the images of the alignment target generated by the imaging subsystem. The computer subsystem is further configured for determining information for the specimen based on results of the aligning. The system may be further configured as described herein.

Another embodiment relates to a method for determining information for a specimen. The method includes acquiring images of the specimen generated by an imaging subsystem. The method also includes the modifying, generating, aligning, and determining steps described above, which are performed by a computer subsystem coupled to the imaging subsystem. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1-2 are schematic diagrams illustrating side views of embodiments of a system configured as described herein;

FIG. 3 includes an example of a rendered image of an alignment target on a specimen that is different from an image of the alignment target generated by an imaging subsystem due to variation in one or more parameters of the imaging subsystem;

FIG. 4 is a schematic diagram illustrating a side view of an embodiment of an imaging subsystem and how an embodiment of a model generates a rendered image for an alignment target on a specimen from information for a design of the alignment target;

FIG. 5 includes the images of FIG. 3 and an example of an additional rendered image of the alignment target on the specimen that is substantially similar to the image of the alignment target generated by the imaging subsystem due to modification of one or more parameters of an embodiment of the model described herein, which may be performed according to the embodiments described herein;

FIG. 6 is a flow chart illustrating one embodiment of steps that may be performed for determining if images generated by a model or a modified model should be used for image alignment;

FIG. 7 is a plot illustrating an example of results generated with a currently used image alignment process and an embodiment of the image alignment described herein; and

FIG. 8 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use in the embodiments described herein well in advance of printing of the design on any physical specimens such as reticles and wafers.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are systems and methods for determining information for a specimen. The embodiments described herein provide improved systems and methods for pixel-to-design (PDA) alignment for applications such as defect detection. The embodiments described herein also provide adaptive PDA methods that can adapt in a number of ways described further herein thereby providing several important improvements over the currently used PDA methods and systems. For example, the embodiments described herein improve on the accuracy and robustness of existing PDA methods and systems by extending the rendering model accuracy to include de-focus and/or by adding adaptive rendering during the inspection to account for runtime specimen process variation.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

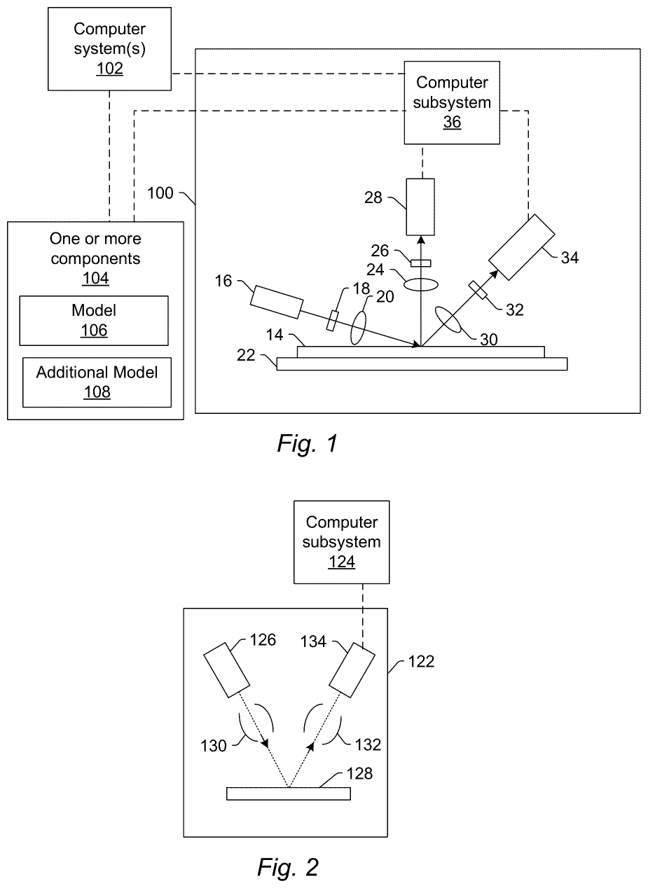

One embodiment of a system configured for determining information for a specimen is shown in FIG. 1. The system includes imaging subsystem 100 configured for generating images of the specimen. The imaging subsystem includes and/or is coupled to a computer subsystem, e.g., computer subsystem 36 and/or one or more computer systems 102.

In general, the imaging subsystems described herein include at least an energy source, a detector, and a scanning subsystem. The energy source is configured to generate energy that is directed to a specimen by the imaging subsystem. The detector is configured to detect energy from the specimen and to generate output responsive to the detected energy. The scanning subsystem is configured to change a position on the specimen to which the energy is directed and from which the energy is detected. In one embodiment, as shown in FIG. 1, the imaging subsystem is configured as a light-based subsystem.

In the light-based imaging subsystems described herein, the energy directed to the specimen includes light, and the energy detected from the specimen includes light. For example, in the embodiment of the system shown in FIG. 1, the imaging subsystem includes an illumination subsystem configured to direct light to specimen 14. The illumination subsystem includes at least one light source. For example, as shown in FIG. 1, the illumination subsystem includes light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the process being performed on the specimen.

The illumination subsystem may be configured to direct the light to the specimen at different angles of incidence at different times. For example, the imaging subsystem may be configured to alter one or more characteristics of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence.

In some instances, the imaging subsystem may be configured to direct light to the specimen at more than one angle of incidence at the same time. For example, the illumination subsystem may include more than one illumination channel, one of the illumination channels may include light source 16, optical element 18, and lens 20 as shown in FIG. 1 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the illumination subsystem may include only one light source (e.g., source 16 shown in FIG. 1) and light from the light source may be separated into different optical paths (e.g., based on wavelength, polarization, etc.) by one or more optical elements (not shown) of the illumination subsystem. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, optical element 18 may be configured as a spectral filter and the properties of the spectral filter can be changed in a variety of different ways (e.g., by swapping out one spectral filter with another) such that different wavelengths of light can be directed to the specimen at different times. The illumination subsystem may have any other suitable configuration known in the art for directing light having different or the same characteristics to the specimen at different or the same angles of incidence sequentially or simultaneously.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). The laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for generating images.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. In instances in which the light is scanned over the specimen, the light may be scanned over the specimen in any suitable fashion such as in a serpentine-like path or in a spiral path.

The imaging subsystem further includes one or more detection channels. At least one of the detection channel(s) includes a detector configured to detect light from the specimen due to illumination of the specimen by the imaging subsystem and to generate output responsive to the detected light. For example, the imaging subsystem shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

As further shown in FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). In one such instance, the detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels has its own collector, each of which is configured to collect light at different scattering angles than each of the other collectors.

As described further above, each of the detection channels included in the imaging subsystem may be configured to detect scattered light. Therefore, the imaging subsystem shown in FIG. 1 may be configured for dark field (DF) imaging of specimens. However, the imaging subsystem may also or alternatively include detection channel(s) that are configured for bright field (BF) imaging of specimens. In other words, the imaging subsystem may include at least one detection channel that is configured to detect light specularly reflected from the specimen. Therefore, the imaging subsystems described herein may be configured for only DF, only BF, or both DF and BF imaging. Although each of the collectors are shown in FIG. 1 as single refractive optical elements, each of the collectors may include one or more refractive optical elements and/or one or more reflective optical elements.

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the imaging subsystem may be signals or data, but not image signals or image data. In such instances, a computer subsystem such as computer subsystem 36 may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

It is noted that FIG. 1 is provided herein to generally illustrate a configuration of an imaging subsystem that may be included in the system embodiments described herein. Obviously, the imaging subsystem configuration described herein may be altered to optimize the performance of the imaging subsystem as is normally performed when designing a commercial system. In addition, the systems described herein may be implemented using an existing system (e.g., by adding functionality described herein to an existing system) such as the 29xx/39xx series of tools that are commercially available from KLA Corp., Milpitas, Calif. For some such systems, the methods described herein may be provided as optional functionality of the system (e.g., in addition to other functionality of the system). Alternatively, the system described herein may be designed “from scratch” to provide a completely new system.

Computer subsystem 36 may be coupled to the detectors of the imaging subsystem in any suitable manner (e.g., via one or more transmission media, which may include “wired” and/or “wireless” transmission media) such that the computer subsystem can receive the output generated by the detectors. Computer subsystem 36 may be configured to perform a number of functions with or without the output of the detectors including the steps and functions described further herein. As such, the steps described herein may be performed “on-tool,” by a computer subsystem that is coupled to or part of an imaging subsystem. In addition, or alternatively, computer system(s) 102 may perform one or more of the steps described herein. Therefore, one or more of the steps described herein may be performed “off-tool,” by a computer system that is not directly coupled to an imaging subsystem. Computer subsystem 36 and computer system(s) 102 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

Although the imaging subsystem is described above as being an optical or light-based imaging subsystem, in another embodiment, the imaging subsystem is configured as an electron-based subsystem. In an electron beam imaging subsystem, the energy directed to the specimen includes electrons, and the energy detected from the specimen includes electrons. In one such embodiment shown in FIG. 2, the imaging subsystem includes electron column 122, and the system includes computer subsystem 124 coupled to the imaging subsystem. Computer subsystem 124 may be configured as described above. In addition, such an imaging subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate images for the specimen as described further herein (e.g., with different illumination angles, collection angles, etc.). The multiple modes of the electron beam imaging subsystem may be different in any imaging parameters of the imaging subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to determine information for the specimen using output generated by detector 134, which may be performed as described further herein. Computer subsystem 124 may be configured to perform any additional step(s) described herein. A system that includes the imaging subsystem shown in FIG. 2 may be further configured as described herein.

It is noted that FIG. 2 is provided herein to generally illustrate a configuration of an electron beam imaging subsystem that may be included in the embodiments described herein. As with the optical subsystem described above, the electron beam subsystem configuration described herein may be altered to optimize the performance of the imaging subsystem as is normally performed when designing a commercial system. In addition, the systems described herein may be implemented using an existing system (e.g., by adding functionality described herein to an existing system) such as tools that are commercially available from KLA. For some such systems, the methods described herein may be provided as optional functionality of the system (e.g., in addition to other functionality of the system). Alternatively, the system described herein may be designed “from scratch” to provide a completely new system.

Although the imaging subsystem is described above as being a light or electron beam subsystem, the imaging subsystem may be an ion beam imaging subsystem. Such an imaging subsystem may be configured as shown in FIG. 2 except that the electron beam source may be replaced with any suitable ion beam source known in the art. In addition, the imaging subsystem may include any other suitable ion beam imaging system such as those included in commercially available focused ion beam (FIB) systems, helium ion microscopy (HIM) systems, and secondary ion mass spectroscopy (SIMS) systems.

As further noted above, the imaging subsystem may be configured to have multiple modes. In general, a “mode” is defined by the values of parameters of the imaging subsystem used to generate images for the specimen. Therefore, modes that are different may be different in the values for at least one of the imaging parameters of the imaging subsystem (other than position on the specimen at which the images are generated). For example, for a light-based imaging subsystem, different modes may use different wavelengths of light. The modes may be different in the wavelengths of light directed to the specimen as described further herein (e.g., by using different light sources, different spectral filters, etc. for different modes). In another embodiment, different modes may use different illumination channels. For example, as noted above, the imaging subsystem may include more than one illumination channel. As such, different illumination channels may be used for different modes.

The multiple modes may also be different in illumination and/or collection/detection. For example, as described further above, the imaging subsystem may include multiple detectors. Therefore, one of the detectors may be used for one mode and another of the detectors may be used for another mode. Furthermore, the modes may be different from each other in more than one way described herein (e.g., different modes may have one or more different illumination parameters and one or more different detection parameters). In addition, the multiple modes may be different in perspective, meaning having either or both of different angles of incidence and angles of collection, which are achievable as described further above. The imaging subsystem may be configured to scan the specimen with the different modes in the same scan or different scans, e.g., depending on the capability of using multiple modes to scan the specimen at the same time.

In another embodiment, the imaging subsystem is configured as an inspection subsystem. The inspection subsystem may be configured for performing inspection using light, electrons, or another energy type such as ions. Such an imaging subsystem may be configured, for example, as shown in FIGS. 1 and 2. In systems in which the imaging subsystem is configured as an inspection subsystem, the computer subsystem may be configured for detecting defects on the specimen based on the output generated by the imaging subsystem. For example, in possibly the simplest scenario, the computer subsystem may subtract a reference from the images thereby generating a difference image and then apply a threshold to the difference image. The computer subsystem may determine that any difference image having a value above the threshold contains a defect or potential defect and that any difference image having a value below the threshold does not contain a defect or potential defect. Of course, many defect detection methods and algorithms used on commercially available inspection tools are much more complicated than this example, and any such methods or algorithms may be applied to the output generated by the imaging subsystem configured as an inspection subsystem.

The systems described herein may also or alternatively be configured as another type of semiconductor-related quality control type system such as a defect review system and a metrology system. For example, the embodiments of the imaging subsystems described herein and shown in FIGS. 1-2 may be modified in one or more parameters to provide different imaging capability depending on the application for which they will be used. In one embodiment, the imaging subsystem is configured as an electron beam defect review subsystem. For example, the imaging subsystem shown in FIG. 2 may be configured to have a higher resolution if it is to be used for defect review or metrology rather than for inspection. In other words, the embodiments of the imaging subsystem shown in FIGS. 1-2 describe some general and various configurations for an imaging subsystem that can be tailored in a number of manners that will be obvious to one skilled in the art to produce imaging subsystems having different imaging capabilities that are more or less suitable for different applications.

As noted above, the imaging subsystem may be configured for directing energy (e.g., light, electrons) to and/or scanning energy over a physical version of the specimen thereby generating actual (or “real”) images for the physical version of the specimen. In this manner, the imaging subsystem may be configured as an “actual” imaging system, rather than a “virtual” system. However, a storage medium (not shown) and computer system(s) 102 shown in FIG. 1 and/or other computer subsystems shown and described herein may be configured as a “virtual” system. In particular, the storage medium and computer system(s) 102 are not part of imaging subsystem 100 and do not have any capability for handling the physical version of the specimen but may be configured as a virtual inspector that performs inspection-like functions, a virtual metrology system that performs metrology-like functions, a virtual defect review tool that performs defect review-like functions, etc. using stored detector output. Systems and methods configured as “virtual” systems are described in commonly assigned U.S. Pat. No. 8,126,255 issued on Feb. 28, 2012 to Bhaskar et al., U.S. Pat. No. 9,222,895 issued on Dec. 29, 2015 to Duffy et al., and U.S. Pat. No. 9,816,939 issued on Nov. 14, 2017 to Duffy et al., which are incorporated by reference as if fully set forth herein. The embodiments described herein may be further configured as described in these patents. For example, a computer subsystem described herein may be further configured as described in these patents.

The system includes one or more components executed by the computer subsystem. For example, as shown in FIG. 1, the system includes one or more components 104 executed by computer subsystem 36 and/or computer system(s) 102. Systems shown in other figures described herein may be configured to include similar elements. The one or more components may be executed by the computer subsystem as described further herein or in any other suitable manner known in the art. At least part of executing the one or more components may include inputting one or more inputs, such as images, data, etc., into the one or more components. The computer subsystem may be configured to input any design data, information, etc. into the one or more components in any suitable manner.

Although some embodiments are described herein with respect to “an alignment target,” the embodiments described herein can obviously be performed for more than one alignment target on the same specimen and in the same process. One or more of the alignment targets on the specimen may be different, or all of the alignment targets may be the same. The alignment targets may be any suitable alignment targets known in the art, which may be selected in any suitable manner known in the art. Information for the alignment targets that may be used for one or more steps described herein may be acquired by the embodiments described herein in any suitable manner. For example, a computer subsystem configured as described herein may acquire information for the alignment target(s) from a storage medium in which the information has been stored by the computer subsystem itself or by another system or method. In some instances, results generated by the embodiments described herein may be applied to or used for more than one instance of an alignment target having the same design and formed in more than one position on the specimen. For example, a rendered image generated for an alignment target on the specimen may be used for each instance of the alignment target on the specimen having the same design.

The one or more components include a model configured for generating a rendered image for an alignment target on the specimen from information for a design of the alignment target. The rendered image is a simulation of the images of the alignment target on the specimen generated by the imaging subsystem. For example, as shown in FIG. 1, one or more components 104 include model 106. The input to the model may be any information for the design including the design data itself. The output of the model is a rendered image that simulates how the alignment target will look in an image of the portion of the specimen in which the alignment target is formed. The model therefore performs a design-to-optical transformation. (Although some embodiments may be described herein with respect to optical images or optical use cases, the embodiments may be equally configured for other images described herein or other imaging processes described herein.)

The rendered image may be substantially different from the design for the alignment target as well as how the alignment target is actually formed on the specimen. For example, marginalities in the process used to form the alignment target on the specimen may cause the alignment target on the specimen to be substantially or at least somewhat different than the design for the alignment target. In addition, marginalities in the imaging subsystem used to generate images of the alignment target on the specimen may cause the images of the alignment target to appear substantially or at least somewhat different than both the design for the alignment target and the alignment target formed on the specimen.

In one embodiment, the model is a partial coherent physical model (PCM), which may have any format, configuration, or architecture known in the art. The embodiments described herein provide a new rendering model concept. In rendering, a numerical model (developed from optics theory) is used to generate a rendered image via simulation of the imaging process. In other words, the model is a physical model that simulates the imaging process. The model may also perform a multi-layer rendering. The model may be setup by an iterative optimization process designed to minimize the differences between real specimen images and rendered specimen images. This setup or training may be performed in any suitable manner known in the art.

FIG. 4 illustrates a simplistic version of an imaging subsystem described herein with illustrations showing how the model simulates the imaging process. In this imaging subsystem, specimen 400 may include substrate 402 such as a silicon substrate on which layers 404, 406, and 408 are formed, which may include any suitable layers known in the art such as dielectric layers. As shown in FIG. 4, these layers may have patterned areas formed within (which is shown in FIG. 4 by the differently shaded areas within the layers). However, one or more of the layers may be unpatterned. In addition, the specimen may include a different number of layers than that shown in FIG. 4, e.g., fewer than three layers or more than three layers.

This simplified version of the imaging subsystem is shown to include light source 412, which generates light 414 that is directed to illumination aperture 416, which has a number of apertures 418 formed therein. Light 420 that passes through apertures 418 may then be directed to upper surface 410 of specimen 400. Near field 422 resulting from illumination of upper surface 410 of specimen 400 may be collected by imaging lens 424, which focuses light 426 to detector 428. Imaging lens 424 may have focal length 430, d. Each of these elements of the imaging subsystem may be further configured as described herein. In addition, this version of the imaging subsystem may be further configured as described herein.

Layer images, L, 432 may be input to model 106 shown in FIG. 1, which may first render near field, \vec{E}, 436. The layer images may be generated in any suitable manner. For example, information for the design of the specimen such as design polygons may be input to a database raster step that generates the layer images. This near field rendering simulation then approximates portion 434 of the imaging process from the layer images L to the near field proximate upper surface 410 of specimen 400. The model may simulate the near field as \vec{E}=η(L), where η consumes excitation information. Near field 436 may be used to simulate rendered image, I, 440 by simulating portion 438 of the imaging process from the near field to the image plane at the detector. This portion of the imaging process may be simulated by I=f (|\vec{E}|²), where f consumes wavelength, numerical aperture (NA), excitation mode, etc.

In the currently used PDA (“POR PDA”), f always assumes defocus is 0, i.e., d=focal length. In addition, n does not consume polarization information. Therefore, when the focal length changes and/or the polarization is different than expected, the optical images simulated by POR PDA may be sufficiently different from the images generated by the imaging subsystem to thereby cause errors in the PDA or even prevent the PDA from being performed at all.

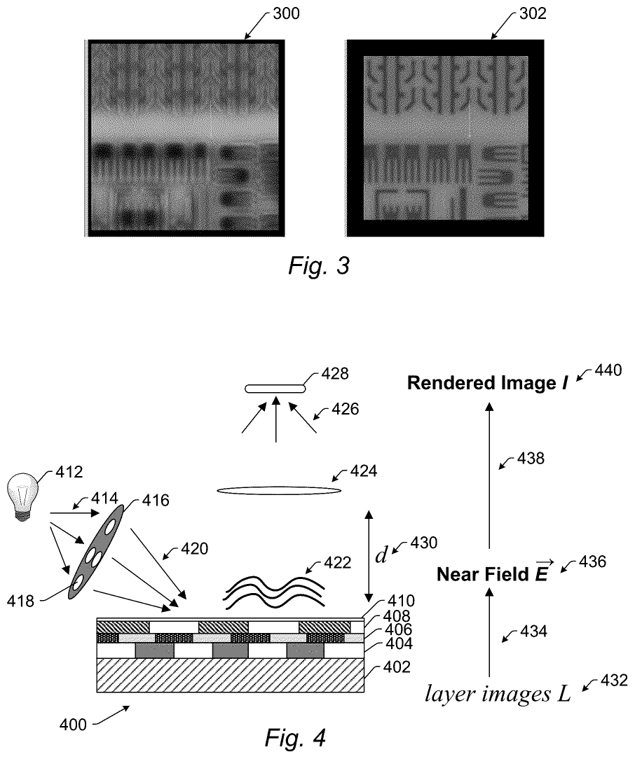

FIG. 3 shows one example of real optical image 300 that may be generated for an alignment target site by an imaging subsystem described herein. POR PDA may generate rendered image 302 for this same alignment target site. As shown by rendered image 302, the image is in-focus and the horizontal and vertical edges look the same. In contrast, real optical image 300 is clearly not in-focus as evidenced by the blurriness of the image, and the polarization is different than expected because the horizontal and vertical edges in the real optical image are clearly different. For example, the horizontal edges are somewhat blurry in the real optical image compared to the same horizontal edges in the rendered image, but the vertical images are completely different in the real optical image and the rendered image, e.g., they are different in color or contrast in addition to being blurrier in the optical image than the rendered image. In this manner, alignment of optical image 300 to rendered image 302 may be difficult or even impossible, and any image alignment performed based on results of this alignment may be erroneous.

The computer subsystem is configured for modifying one or more parameters of the model based on one or more of variation in one or more parameters of the imaging subsystem and variation in one or more process conditions used to fabricate the specimen. For example, the embodiments described herein may be configured to improve the accuracy of the rendered images in a couple of different ways and to accommodate a couple of different ways in which the real optical images may be different than expected. One of the ways that the real images may be different than rendered images is due to changes in the imaging subsystem, e.g., when the imaging subsystem is out-of-focus and/or a focus setting changes. Another of the ways that the real images may be different than the rendered images is due to variations in the specimen caused by changing process conditions, which may therefore affect the real images that are generated of the specimen by the imaging subsystem. The embodiments described herein may be configured for modifying parameter(s) of the model based on only variation in parameter(s) of the imaging subsystem or only variation in process condition(s). However, the embodiments may also or alternatively be configured for modifying parameter(s) of the model based on both variation in parameter(s) of the imaging subsystem and variation in process condition(s).

Modifying the parameter(s) of the model based on variation in parameter(s) of the imaging subsystem may include adding focus and/or polarization terms to the PDA algorithm rendering model, i.e., the PCM model or another suitable model configured as described herein. In one embodiment, therefore, modifying the one or more parameters of the model includes adding a defocus term to the model. For example, the computer subsystem may add a defocus term to f and n described above, which may be performed in any suitable manner known in the art. In another embodiment, the one or more parameters of the imaging subsystem include a focus setting of the imaging subsystem. For example, if a model includes a defocus term or is modified to include a defocus term as described above, then the computer subsystem may modify the defocus term based on a focus setting of the imaging subsystem, which may be performed in any suitable manner known in the art.

In some embodiments, modifying the one or more parameters of the model includes adding a polarization term to the model. For example, the computer subsystem may add a polarization term to f and n described above, which may be performed in any suitable manner known in the art. In a further embodiment, the one or more parameters of the imaging subsystem include a polarization setting of the imaging subsystem. For example, if a model includes a polarization term or is modified to include a polarization term as described above, then the computer subsystem may modify the polarization term based on a polarization setting of the imaging subsystem, which may be performed in any suitable manner known in the art. Unlike the embodiments described herein, rendering models currently used for PDA do not account for optical image defocus which can result in a poor match between the acquired optical image and the rendered image thereby resulting in relatively poor PDA alignment. The currently used methods also assume the focus error is zero and do not account for polarization. The polarization may need to be accounted for when there is some defocus in the real optical images. For example, the original model (without polarization terms) works fine when the specimen images are in focus, but the polarization used for imaging may cause the real optical images to look substantially different than the rendered images when there is some defocus in the imaging process.

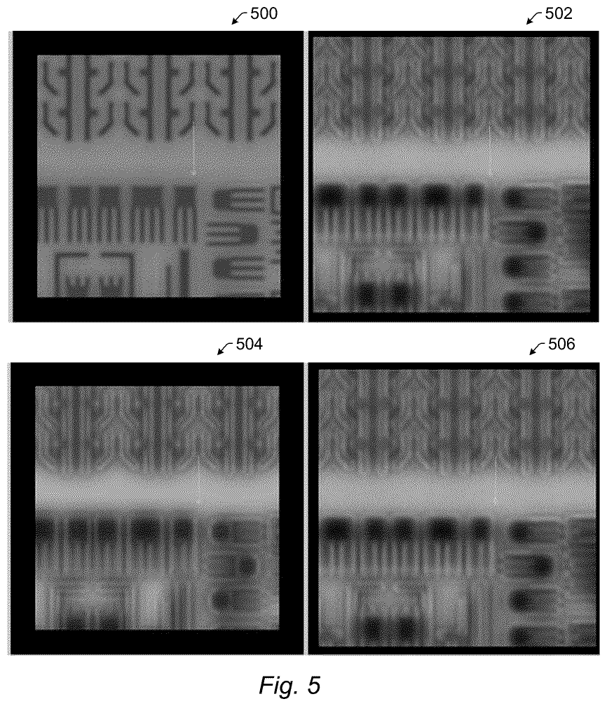

FIG. 5 shows an example of an image obtained using the new rendering model generated by modifying the one or more parameters of the model as described herein. In this embodiment, POR PDA may generate rendered image 500 for an in-focus condition with expected polarization. As described further above, this rendered image has significant differences from real optical image 502. As a result, the rendered image is a relatively poor approximation of the real optical image, and the images will most likely be misaligned to each other in any alignment performed therefor.

In contrast, a model that is modified as described herein to account for changes in the focus setting and polarization of the imaging process will generate rendered image 504 that much better represents real optical image 506 (real optical images 502 and 506 are the same in this example). As can be seen from rendered image 504 and optical image 506, the rendered image looks much more similar to the optical image than rendered image 500. As a result, alignment of images 504 and 506 will most likely be successful and can therefore be successfully used to align other images to each other. For example, experimental results generated by the inventors using the new rendering model described herein (generated by modifying the current model) have shown that images rendered using the new rendering model can be successfully aligned to real optical images for different modes, different wafers, and different focus settings from 0 to +300 or even +400. In addition, the experimental results have shown that the new PDA methods and systems described herein can improve the performance without sacrificing the throughput (e.g., the average time to generate PDA using the embodiments described herein was about the same and even a bit faster than the currently used methods).

In one embodiment, the computer subsystem is further configured for acquiring the one or more parameters of the imaging subsystem from a recipe for a process used for determining the information for the specimen. For example, the focus and polarization are determined by the optical mode used on the tool. These values can pass from the recipe parameters to the model. In particular, because the model is modified to include terms for focus and polarization, these settings can be input to the model directly from the recipe used for the process (e.g., inspection, metrology, etc.). A “recipe” is generally defined in the art as instructions that can be used for carrying out a process. A recipe for one of the processes described herein may therefore include information for various imaging subsystem parameters to be used for the process as well as any other information that is needed to perform the process in the intended manner. In some such embodiments, the computer subsystem may access the recipe from the storage medium (not shown) in which it is stored (which may be a storage medium in the computer subsystem itself) and import the recipe or the information contained therein into the model. Of course, there are a variety of other ways in which the recipe parameter information can be input to the model, and any of such ways may be used in the embodiments described herein.

As described above, the embodiments may account for process variation and the effects that process variation can have on PDA. For example, PDA runtime may fail for specimens with relatively strong process variation from the setup specimen. In particular, due to process variation, runtime images may look significantly different from the setup image. To mitigate the effects of process variation on the PDA runtime process, the embodiments described herein can make PDA adaptive during runtime. For example, if process variation exists on a specimen, the runtime images may differ significantly from setup images. Therefore, by determining if such image differences exist before performing alignment, alignment failure can be avoided by generating new alignment target rendered images. To make the PDA runtime process adaptive also means rendering images during runtime (or at least after setup has been completed and runtime has commenced).

In an embodiment, the computer subsystem is configured for determining if the at least one of the images of the alignment target is blurry and performing the modifying, generating an additional rendered image as described further herein, and aligning the additional rendered image as described further herein only when the at least one of the images of the alignment target is blurry. In this manner, the embodiments described herein may perform the image rendering only when necessary. For example, a specimen image may look blurred when it is out-of-focus. In particular, the PDA images may be initially generated (e.g., during setup) for in-focus and expected polarization settings. These images may be useful for PDA for the alignment targets unless the real optical images become different than expected. In some such situations, the computer subsystem may acquire the real optical images of the alignment targets and perform some image analysis to determine how blurry the images are. If there is some blurriness in the images, which can be quantified and compared to some threshold separating acceptable and unacceptable levels of blurriness in any suitable manner known in the art, then the computer subsystem may modify one or more parameters of the model and generate one or more additional rendered images for alignment to the optical images exhibiting some blurriness. In this manner, an image characteristic of the real optical images may be examined to determine if they deviate from expected and then new rendered PDA images may be generated for those images that exhibit deviations.

In another embodiment, the computer subsystem is configured for determining if horizontal and vertical features in the at least one of the images of the alignment target look different from each other and performing the modifying, generating an additional rendered image as described further herein, and aligning the additional rendered image as described further herein only when the horizontal and vertical features look different from each other. For example, when the horizontal and vertical lines look different in the specimen images, the polarization of the imaging subsystem may have shifted. In this manner, the embodiments described herein may perform the image rendering only when necessary. In particular, the PDA images may be initially generated for in-focus and expected polarization settings. These images may be useful for PDA for the alignment targets unless the real optical images become different than expected. In some such situations, the computer subsystem may acquire the real optical images of the alignment targets and perform some image analysis to determine how different the horizontal and vertical lines look in the real optical images. If there are some differences in the horizontal and vertical lines in the images, which can be quantified and compared to some threshold separating acceptable and unacceptable levels of differences in any suitable manner known in the art, then the computer subsystem may modify one or more parameters of the model and generate one or more additional rendered images for alignment to the optical images exhibiting some differences. In this manner, an image characteristic of the real optical images may be examined to determine if they deviate from expected and then new rendered PDA images may be generated for those images that exhibit deviations.

Subsequent to modifying the one or more parameters of the model, the computer subsystem is configured for generating an additional rendered image for the alignment target by inputting the information for the design of the alignment target into the model. For example, once the parameter(s) of the model have been modified in one or more of the ways described herein, the model may be used to generate new rendered image(s) for the alignment target that can then be used for alignment as described further herein. The information for the design of the alignment target may include any of the information described herein and may be input to the model in any suitable manner known in the art.

In one embodiment, the computer subsystem is configured for acquiring the information for the design of the alignment target from a storage medium and inputting the acquired information into the model without modifying the acquired information. For example, the information that is input to the model to generate the rendered images does not need to change to make the rendered images appear more similar to the real images. In other words, once the model has been modified as described herein, no changes to the input have to be made. In this manner, the same information that was initially used to generate rendered alignment target images may be reused, without modification, to generate the new rendered alignment target images. As described further herein, being able to reuse the model inputs, without modification, has advantages for the embodiments described herein.

The computer subsystem is also configured for aligning the additional rendered image to at least one of the images of the alignment target generated by the imaging subsystem. In this manner, the image alignment step performed by the embodiments described herein is an alignment between a real image for an alignment target and a rendered image for the alignment target. Other than using the new rendered images described herein, alignment may otherwise be performed in any suitable manner known in the art. In other words, the embodiments described herein and the rendered images that they generate are not particular to any type of alignment process.

Prior to performing the process on the specimen, the rendered image may have been aligned to a design for the specimen. In other words, during setup, the computer subsystem or another system or method may align the rendered image for the alignment target to a design for the specimen. Based on results of this alignment, the coordinates of the design aligned to the rendered alignment target image may be assigned to the rendered alignment target image or some coordinate shift between the rendered alignment target image and the design may be established. (As used herein, the term “shift” is defined as an absolute distance to design, which is different than an “offset,” which is defined herein as a relative distance between two optical images.) Then, during runtime, the rendered alignment target image may be aligned to the real alignment target image(s) thereby aligning the real alignment target image(s) to the design, e.g., based on the information generated by aligning the rendered alignment target image to the design during setup. In this manner, during runtime, the alignment step may be an optical-to-rendered optical alignment step that results in an optical-to-design alignment. Performing alignment in this manner during runtime makes that process much faster and makes the throughput of the process much better.

Unlike the embodiments described herein, POR PDA performs all rendering for the PDA sites on the specimen prior to inspection using the known locations of the PDA image sites. These methods and systems cannot, therefore, account for process variation (intra-wafer or wafer-to-wafer) that can occur and degrade the match between optical and rendered PDA images. In contrast, the embodiments described herein provide a new PDA method that may include a runtime PDA on-the-fly functionality that can be used to render images adaptively to deal with optical process variation on the specimen.

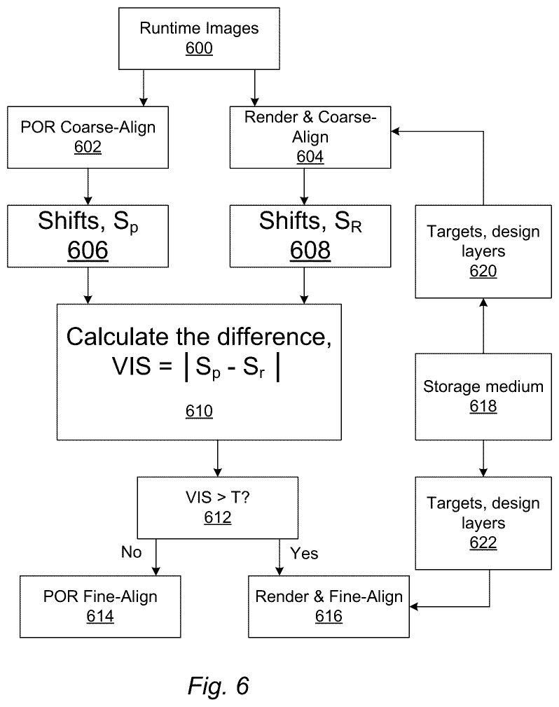

As described above, one way in which the embodiments described herein may be configured to generate new rendered images for PDA on-the-fly may be to examine some characteristic of the real optical images that will be aligned to the rendered images. Another method for PDA on-the-fly is also provided herein. One such embodiment is shown in FIG. 6. In step 600, the computer subsystem acquires runtime images, which may include real optical images as well as one or more rendered images. The rendered images may include POR PDA rendered images (e.g., PDA images generated for an in-focus condition and expected polarization) as well as a new PDA rendered image (e.g., generated for a different focus setting and different polarization).

The images that are generated by the model in the embodiments described herein may be suitable for only coarse alignment or both coarse alignment and fine alignment. In instances in which the rendered images are only suitable for coarse alignment, the model or another model configured as described herein may be used for generating rendered images that are suitable for fine alignment. The coarse and fine alignment described herein may also be different in ways other than just the images that are used for these steps. For example, the coarse alignment may be performed for far fewer alignment targets and/or far fewer instances of the same alignment target than the fine alignment. The alignment method may also be different for coarse and fine alignment and may include any suitable alignment method known in the art.

In one embodiment, aligning the additional rendered image includes a coarse alignment, and the computer subsystem is configured for performing an additional coarse alignment of a stored rendered image for the alignment target to the at least one of the images of the alignment target and determining a difference between results of the coarse alignment and the additional coarse alignment. In this manner, the computer subsystem may perform two different coarse alignments, one with the POR PDA rendered image and another with a new PDA rendered image. For example, as shown in FIG. 6, the computer subsystem may perform additional coarse alignment, which is POR Coarse-Align step 602, of a stored rendered image for the alignment target, i.e., the POR PDA rendered image, to the at least one image of the alignment target, i.e., a real optical image of the alignment target. In addition, the computer subsystem may perform coarse alignment, which is Render & Coarse-Align step 604, of a new rendered image for the alignment target, i.e., the new PDA rendered image, to the at least one image of the alignment target, i.e., the same real optical image of the alignment target. Both of these coarse alignment steps may otherwise be performed in any suitable manner known in the art.

The output of the POR Coarse-Align step 602 may be Shifts, Sₚ, 606 (i.e., the offsets between runtime images and rendered images), and the output of the Render & Coarse-Align step 604 may be Shifts, S_{R}, 608. Both of the shifts may be input to step 610 in which the difference between the shifts may be calculated as variation introduced shift (VIS), VIS=|Sₚ−S_{R}|. The difference between the shifts is an indicator of process variation. Ideally, VIS would be close to 0, meaning that there is no difference between the two shifts. The computer subsystem may calculate VIS per swath of images scanned on the specimen.

In one such embodiment, the computer subsystem is configured for comparing the difference between the results of the coarse alignment and the additional coarse alignment to a threshold and when the difference is less than the threshold, performing a fine alignment using the stored rendered image or a stored fine alignment rendered image for the alignment target. For example, as shown in step 612 of FIG. 6, the computer subsystem may determine if VIS is greater than threshold, T, e.g., T=0.5 pixels. If VIS is not greater than T, the computer subsystem may perform POR Fine-Align as shown in step 614. In other words, the computer subsystem may perform fine alignment using the POR PDA rendered image or a POR PDA rendered image generated specifically for fine alignment. In this manner, coarse and fine alignment may be performed with the same POR PDA rendered image or with different POR PDA rendered images generated specifically for coarse and fine alignment. This and other fine alignment steps described herein may otherwise be performed in any suitable manner known in the art.

In another such embodiment, the computer subsystem is configured for comparing the difference between the results of the coarse alignment and the additional coarse alignment to a threshold and when the difference is greater than the threshold, performing a fine alignment using a fine alignment rendered image for the alignment target. For example, as shown in step 612 of FIG. 6, the computer subsystem may determine if VIS is greater than threshold, T. If VIS is greater than T, the computer subsystem may report process variation because a non-optimal alignment result has been detected. If VIS is greater than T, the computer subsystem may also perform Render & Fine-Align as shown in step 616. In other words, the computer subsystem may perform fine alignment using the PDA image rendered with a model modified as described herein or a PDA image rendered with a model modified as described herein and generated specifically for fine alignment. In this manner, coarse and fine alignment may be performed with the same new PDA rendered image or with different new PDA rendered images generated specifically for coarse and fine alignment.

In some embodiments, subsequent to modifying the parameter(s) of the model, the computer subsystem is configured for generating the fine alignment rendered image by inputting the information for the design of the alignment target into the model. In this manner, the same model that was modified and used to generate the coarse alignment rendered image may also be used to generate the fine alignment rendered image. The fine alignment rendered image may otherwise be generated as described further herein.

In such embodiments, the same information that was initially used for rendering alignment target images may also be used for rendering new alignment target images adaptively and/or during runtime. For example, the parameter(s) of the model may be modified, but the design (and possibly other) information that is used for the rendering will remain the same. As such, all of the information that is initially used for alignment target image rendering may be stored and reused for additional alignment target image rendering. Being able to store and reuse the input to the model can have significant benefits for the embodiments described herein including minimizing any impact that additional alignment target image rendering may have on throughput of the process performed on the specimen.

Depending on the configuration of the system, the design information that is input to the model may be made available in a number of different ways. One way is to retrieve the design information after it has been determined that it is needed for a new image rendering. Another way is to retrieve it depending on which alignment target is being processed so that it is available for rendering upon detection that a new rendered image is needed. For example, the runtime may include a frame data preparation phase in which a runtime optical image is grabbed based on the target location and its corresponding setup optical image and layer images are unpacked at the same time.

As shown in FIG. 6, information for the design of the alignment target may be stored in storage medium 618 by the computer subsystem or another system or method. Storage medium 618 may be further configured as described herein. In some instances, storage medium 618 may be configured as a cache database that contains information for the targets and design layers of the specimen. In this manner, that information may be provided to the various rendering and alignment steps described herein. For example, the computer subsystem may be configured for acquiring targets, design layers 620 from storage medium 618 and inputting that information to Render & Coarse-Align step 604 to thereby generate a rendered coarse alignment PDA image. In a similar manner, the computer subsystem may be configured for acquiring targets, design layers 622 from storage medium 618 and inputting that information to Render & Fine-Align step 616 to thereby generate a rendered fine alignment PDA image. In some instances, targets, design layers 620 and targets, design layers 622 may include the same information and the model may generate either a coarse alignment image or a fine alignment image from the information. In other instances, targets, design layers 620 and targets, design layers 622 may include different information that is suitable for generating either a rendered coarse alignment PDA image or a rendered fine alignment PDA image.

In another embodiment, the computer subsystem is configured for modifying one or more parameters of an additional model based on the one or more of the variation in the one or more parameters of the imaging subsystem and the variation in the one or more of the process conditions and subsequent to modifying the one or more parameters of the additional model, generating the fine alignment rendered image by inputting the information for the design of the alignment target into the additional model and performing the fine alignment by aligning the fine alignment rendered image to the at least one of the images of the alignment target. For example, the system may include additional model 108 shown in FIG. 1. Model 106 may be configured for generating rendered images that are suitable for coarse alignment, and model 108 may be configured for generating rendered images that are suitable for fine alignment. Other than being configured for generating fine alignment rendered images, additional model 108 may be configured as described further herein. For example, models 106 and 108 may both be PCM models configured to perform simulations of the imaging process as shown in FIG. 4. In this case, one or more parameters of the fine alignment model may be modified as described herein to account for one or more of the variations described herein. The new fine alignment rendered images generated by the additional model may then be used as described herein for fine alignment to a real optical (or other) alignment target image. The fine alignment may be performed in any suitable manner known in the art.

The embodiments described herein may therefore involve generating additional rendered images and/or generating new rendered images on-the-fly. Therefore, one consideration that may be made is how this additional image rendering affects throughput of the processes in which the PDA is performed. In general, the inventors believe that any impact on throughput will be minimal or can be reduced in a number of important ways described herein. For instance, in PDA training, a bottleneck of the throughput can be the generation of design polygons. However, the embodiments described herein do not need to regenerate the polygons in the rendering process. Instead, the embodiments described herein can directly use the targets and design layer images saved in the database in the PDA training. For example, targets, design layers 620 and targets, design layers 622 shown in FIG. 6 may be information that is generated in PDA training and stored in storage medium 618 shown in FIG. 6. In this manner, this information can be easily accessed and reused for any runtime image rendering, which will substantially improve the throughput of the PDA process and mitigate any effect that the additional rendering has on the overall process.

The computer subsystem is further configured for determining information for the specimen based on results of the aligning. For example, the results of the aligning may be used to align other images to a common reference (e.g., a design for the specimen). In other words, once a real alignment target image has been aligned to a rendered alignment target image, any offset determined therefrom can be used to align other real specimen images to a design for the specimen. That image alignment may then be used to determine other information for the specimen such as care area (CA) placement as well as detecting defects in the CAs, determining where on the specimen a metrology measurement is to be performed and then making the measurement, etc.

In one embodiment, the computer subsystem is further configured for determining CA placement for the determining step based on the results of the aligning. PDA is crucial to performance of defect inspection. For example, the PDA images are rendered from a design image using one of the models described herein, e.g., a PCM model. The rendered images are then aligned with the true optical image from the specimen to determine the (x,y) positional offset between the two images and thereby the (x,y) positional shift between the true design location and the specimen coordinates. This positional shift is applied as a coordinate correction for accurate CA placement and defect reporting.

Accurate CA placement is needed for almost all inspection processes performed today and is important for a number of reasons. For example, if inspection is performed on an entire image frame generated by an inspection process, defects can be buried in the noise in the image frame. To boost sensitivity of the inspection process, CAs are used to exclude noise from areas of interest and they should be as small as possible to exclude as much noise as possible. Placement of the substantially small CAs used today (e.g., as small as a single pixel) is basically impossible to do manually because of the time involved as well as the relatively low accuracy of such methods. Therefore, most CA methods and systems used today are design-based, which when configured properly can make sub-pixel accuracy possible as well as enabling the location of hot spots. To make such CA placement possible, the specimen images must be mapped to the design coordinates, which is what PDA does. The embodiments described herein make the accuracy of the CA placement required by many currently used inspection methods and systems more achievable than currently used methods and systems for image to design alignment.

Accurate PDA is required for accurate CA placement, which is in turn used to enable extremely sensitive defect detection algorithms and/or methods. In addition, the embodiments described herein can be used to improve any PDA type method or system that involves or uses rendered optical images for alignment to real optical images. For example, the embodiments described herein can be used to improve PDA type methods and systems used for manually generated care areas which may be relatively large as well as much smaller CAs such as 5×5 pixel CAs, 3×3 pixel CAs, and even 1×1 pixel CAs. Furthermore, the embodiments described herein can be used with any other PDA type methods and systems including those that have been developed to be more robust to other types of image changes such as changes in image contrast. In this manner, the embodiments described herein may be used for improving any type of optical image to rendered image alignment process in which alignment could fail when there is relatively large defocus and/or when alignment could fail for specimens with relatively strong process variations.

Once the CAs have been placed based on the results of the alignment, defect detection may be performed by the embodiments described herein. In one suitable defect detection method, a reference may be subtracted from a test image to thereby generate a difference image. A threshold may be applied to the pixels in the difference image. Any pixels in the difference image having a value above the threshold may be identified as defects, defect candidates, or potential defects while any pixels in the difference image that do not have a value above the threshold are not so identified. Of course, this is perhaps the simplest method that can be used for defect detection, and the embodiments described herein may be configured for using any suitable defect detection method and/or algorithm for determining the information for the specimen. In this manner, the information determined for the specimen may include information for any defects, defect candidates, or potential defects detected on the specimen.

In a similar manner, when the process is another process like metrology, once the images have been aligned to the design or another common reference by the embodiments described herein, the metrology or other process may be performed at the desired locations on the specimen. The embodiments described herein may be configured to perform any suitable metrology method or process on the specimen using any suitable measurement algorithm or method known in the art. In this manner, the information determined for the specimen by the embodiments described herein may include any results of any measurements performed on the specimen.

The computer subsystem may also be configured for generating results that include the determined information, which may include any of the results or information described herein. The results of determining the information may be generated by the computer subsystem in any suitable manner. All of the embodiments described herein may be configured for storing results of one or more steps of the embodiments in a computer-readable storage medium. The results may include any of the results described herein and may be stored in any manner known in the art. The results that include the determined information may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. For example, the results of the alignment step, the information for the detected defects, etc. may be stored and used as described herein or in any other suitable manner. Such results produced by the computer subsystem may include information for any defects detected on the specimen such as location, etc., of the bounding boxes of the detected defects, detection scores, information about defect classifications such as class labels or IDs, any defect attributes determined from any of the images, etc., specimen structure measurements, dimensions, shapes, etc. or any such suitable information known in the art. That information may be used by the computer subsystem or another system or method for performing additional functions for the specimen and/or the detected defects such as sampling the defects for defect review or other analysis, determining a root cause of the defects, etc.

Such functions also include, but are not limited to, altering a process such as a fabrication process or step that was or will be performed on the specimen in a feedback or feedforward manner, etc. For example, the computer subsystem may be configured to determine one or more changes to a process that was performed on the specimen and/or a process that will be performed on the specimen based on the determined information. The changes to the process may include any suitable changes to one or more parameters of the process. In one such example, the computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown) accessible to both the computer subsystem and the semiconductor fabrication system. The semiconductor fabrication system may or may not be part of the system embodiments described herein. For example, the imaging subsystem and/or the computer subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

The embodiments described herein have a number of advantages in addition to those already described. For example, as described further herein, the embodiments provide improved PDA rendering accuracy by new PCM model terms for defocus and/or polarization and/or adaptive algorithms to render images on-the-fly to account for process variation. The embodiments described herein are also fully customizable and flexible. For example, the new PCM model terms for defocus and/or polarization can be used separately from the adaptive algorithm to render images on-the-fly to account for process variation. In addition, the embodiments described herein provide improved PDA robustness. Furthermore, the embodiments described herein provide improved PDA alignment performance. The embodiments described herein can be used to improve PDA accuracy on inspection tools which can directly result in improved sensitivity performance and increasing the entitlement of defect detection on those tools. These and other advantages described herein are enabled by a number of important new features including, but not limited to, extending the PCM model to include focus and/or polarization and adaptive PDA rendering.

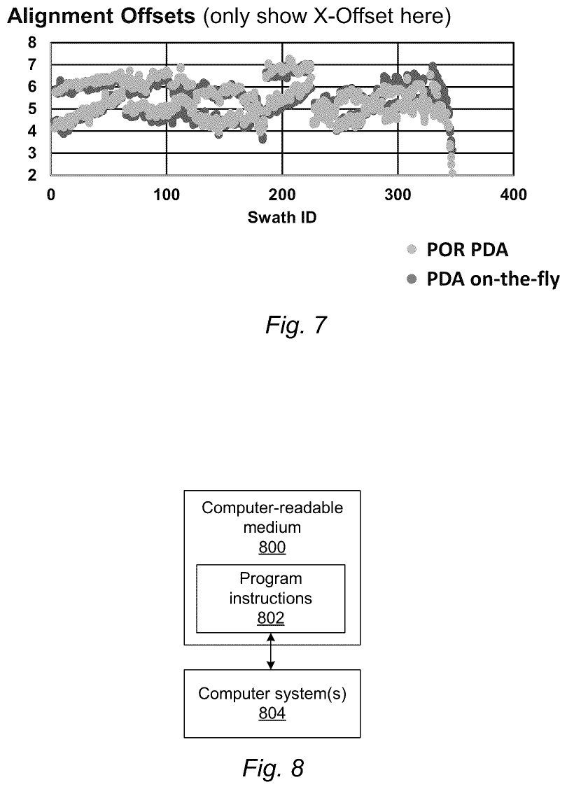

The PDA on-the-fly embodiments described herein are also expected to have very little impact on throughput of the PDA process as well as the overall process. In addition, the PDA on-the-fly embodiments described herein are expected to have little to no impact on the sensitivity of the PDA process. For example, FIG. 7 is a plot showing alignment offsets (only showing the X-Offset) determined using a currently used process (POR PDA) and the PDA on-the-fly embodiments described herein for a specimen without process variation. As can be seen in this plot, the alignment offsets determined by both methods are substantially similar which indicates that the sensitivity of the POR PDA method is substantially the same as the PDA on-the-fly embodiments described herein. In other words, for good wafers (wafers without process variation), the embodiments described herein have the same performance as the currently used methods.

Each of the embodiments of each of the systems described above may be combined together into one single embodiment.

Another embodiment relates to a method for determining information for a specimen. The method includes acquiring images of the specimen generated by an imaging subsystem, which may be performed as described further herein. The method also includes the modifying one or more parameters, generating an additional rendered image, aligning the additional rendered image, and determining information steps described herein, which are performed by a computer subsystem coupled to the imaging subsystem.

Each of the steps of the method may be performed as described further herein. The method may also include any other step(s) that can be performed by the system, imaging subsystem, model, and computer subsystem described herein. The system, imaging subsystem, model, and computer subsystem may be configured according to any of the embodiments described herein. The method may be performed by any of the system embodiments described herein.

An additional embodiment relates to a non-transitory computer-readable medium storing program instructions executable on a computer system for performing a computer-implemented method for determining information for a specimen. One such embodiment is shown in FIG. 8. In particular, as shown in FIG. 8, non-transitory computer-readable medium 800 includes program instructions 802 executable on computer system(s) 804. The computer-implemented method includes the steps described above. The computer-implemented method may further include any step(s) of any method(s) described herein.

Program instructions 802 implementing methods such as those described herein may be stored on computer-readable medium 800. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system(s) 804 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system configured for determining information for a specimen, comprising:
an imaging subsystem configured for generating images of the specimen;
a model configured for generating a rendered image for an alignment target on the specimen from information for a design of the alignment target, wherein the rendered image is a simulation of the images of the alignment target on the specimen generated by the imaging subsystem; and
a computer subsystem configured for:
modifying one or more parameters of the model based on one or more of variation in one or more parameters of the imaging subsystem and variation in one or more process conditions used to fabricate the specimen;
subsequent to said modifying, generating an additional rendered image for the alignment target by inputting the information for the design of the alignment target into the model;
aligning the additional rendered image to at least one of the images of the alignment target generated by the imaging subsystem; and
determining information for the specimen based on results of said aligning.

2. The system of claim 1, wherein the model is a partial coherent physical model.

3. The system of claim 1, wherein said modifying comprises adding a defocus term to the model.

4. The system of claim 1, wherein the one or more parameters of the imaging subsystem comprise a focus setting of the imaging subsystem.

5. The system of claim 1, wherein said modifying comprises adding a polarization term to the model.

6. The system of claim 1, wherein the one or more parameters of the imaging subsystem comprise a polarization setting of the imaging subsystem.

7. The system of claim 1, the computer subsystem is further configured for acquiring the one or more parameters of the imaging subsystem from a recipe for a process used for said determining.

8. The system of claim 1, wherein the computer subsystem is further configured for determining if the at least one of the images of the alignment target is blurry and performing the modifying, generating the additional rendered image, and aligning the additional rendered image only when the at least one of the images of the alignment target is blurry.

9. The system of claim 1, wherein the computer subsystem is further configured for determining if horizontal and vertical features in the at least one of the images of the alignment target look different from each other and performing the modifying, generating the additional rendered image, and aligning the additional rendered image only when the horizontal and vertical features look different from each other.

10. The system of claim 1, wherein the computer subsystem is further configured for acquiring the information for the design of the alignment target from a storage medium and inputting the acquired information into the model without modifying the acquired information.

11. The system of claim 1, wherein aligning the additional rendered image comprises a coarse alignment, and wherein the computer subsystem is further configured for performing an additional coarse alignment of a stored rendered image for the alignment target to the at least one of the images of the alignment target and determining a difference between results of the coarse alignment and the additional coarse alignment.

12. The system of claim 11, wherein the computer subsystem is further configured for comparing the difference between the results of the coarse alignment and the additional coarse alignment to a threshold and when the difference is less than the threshold, performing a fine alignment using the stored rendered image or a stored fine alignment rendered image for the alignment target.

13. The system of claim 11, wherein the computer subsystem is further configured for comparing the difference between the results of the coarse alignment and the additional coarse alignment to a threshold and when the difference is greater than the threshold, performing a fine alignment using a fine alignment rendered image for the alignment target.

14. The system of claim 13, wherein subsequent to said modifying, the computer subsystem is further configured for generating the fine alignment rendered image by inputting the information for the design of the alignment target into the model.

15. The system of claim 13, wherein the computer subsystem is further configured for modifying one or more parameters of an additional model based on the one or more of the variation in the one or more parameters of the imaging subsystem and the variation in the one or more of the process conditions, subsequent to modifying the one or more parameters of the additional model, generating the fine alignment rendered image by inputting the information for the design of the alignment target into the additional model, and performing the fine alignment by aligning the fine alignment rendered image to the at least one of the images of the alignment target.

16. The system of claim 1, wherein the computer subsystem is further configured for determining care area placement for the determining step based on the results of said aligning.

17. The system of claim 1, wherein the imaging subsystem is further configured as an inspection subsystem.

18. The system of claim 1, wherein the imaging subsystem is a light-based subsystem.

19. A non-transitory computer-readable medium, storing program instructions executable on a computer system for performing a computer-implemented method for determining information for a specimen, wherein the computer-implemented method comprises:
acquiring images of the specimen generated by an imaging subsystem;
modifying one or more parameters of a model based on one or more of variation in one or more parameters of the imaging subsystem and variation in one or more process conditions used to fabricate the specimen, wherein the model is configured for generating a rendered image for an alignment target on the specimen from information for a design of the alignment target, and wherein the rendered image is a simulation of the images of the alignment target on the specimen generated by the imaging subsystem;
subsequent to said modifying, generating an additional rendered image for the alignment target by inputting the information for the design of the alignment target into the model;
aligning the additional rendered image to at least one of the images of the alignment target generated by the imaging subsystem; and
determining information for the specimen based on results of said aligning, wherein said acquiring, modifying, generating, aligning, and determining are performed by the computer system.

20. A method for determining information for a specimen, comprising:
acquiring images of the specimen generated by an imaging subsystem;
modifying one or more parameters of a model based on one or more of variation in one or more parameters of the imaging subsystem and variation in one or more process conditions used to fabricate the specimen, wherein the model is configured for generating a rendered image for an alignment target on the specimen from information for a design of the alignment target, and wherein the rendered image is a simulation of the images of the alignment target on the specimen generated by the imaging subsystem;
subsequent to said modifying, generating an additional rendered image for the alignment target by inputting the information for the design of the alignment target into the model;
aligning the additional rendered image to at least one of the images of the alignment target generated by the imaging subsystem; and
determining information for the specimen based on results of said aligning, wherein said acquiring, modifying, generating, aligning, and determining are performed by a computer subsystem coupled to the imaging subsystem.
